(19) United States
(12) Patent Application Publication
(10) Pub. No.: US 2022/0356696 A1
(43) Pub. Date: Nov. 10, 2022

(54) CONNECTION ELEMENT FOR A POST-AND-BEAM OR ROD CONSTRUCTION AND METHOD FOR PRODUCING SUCH A CONNECTION ELEMENT

(71) Applicant: Lithium Designers GmbH, Frankfurt am Main (DE)

(72) Inventors: Alamir MOHSEN, Frankfurt am Main (DE); Holger STRAUSS, Schwetzingen (DE)

(21) Appl. No.: 17/771,925

(22) PCT Filed: Oct. 1, 2020
(86) PCT No.: PCT/EP2020/077563

§ 371 Date: Apr. 26, 2022

(30) Foreign Application Priority Data
Oct. 30, 2019 (DE) 10 2019 129 283.2

(51) Int. Cl. E04B 1/19

(52) U.S. Cl. CPC E04B 1/1903; E04B 2001/1933; E04B 2001/1936; E04B 2001/199; B33Y 80/00

(57) ABSTRACT

The invention relates to a connection element for a post-and-beam or rod construction of a facade system, wherein the connection element has a connection part which is manufactured by means of an additive manufacturing process for metals and which is formed by a plurality of different three-dimensionally curved regions.

The present invention relates in general to structural elements for façade systems and in particular to connecting elements for a mullion/transom or beam structure of a façade system, wherein the connecting elements can in particular be designed as connecting nodes.

A mullion/transom or beam structure is a construction method for façades which allows producing extremely intricate glass façades. In mullion/transom structures, load is transferred by the vertical mullions to which the horizontal transoms are attached. The infill elements of the façade system are held in place by horizontal and vertical pressure bars screwed onto the mullions or transoms of the mullion/transom structure. Steel and aluminum in particular, but also wood, are currently being used as load-bearing materials.

Standard mullion/transom façade systems have been established and accepted on the market for many years. These systems have gone through a long process of testing and development from which they have matured into established products.

A limitation of the currently known mullion/transom façade systems becomes apparent when the complexity of a proposed design or a proposed building geometry exceeds specified system limits. This is particularly because the connecting points (connecting nodes) via which the individual mullion/transom elements are connected together in standard mullion/transom façade systems are limited to one specific predetermined angular range able to accommodate deformations from orthogonal planes.

As the complexity of architectural geometries grows, there is an increasing need particularly for connecting elements which also allow for complex façade and building envelopes to be realized.

Based on this problem as set forth, the present invention is therefore based on the task of specifying a connecting element, in particular for a mullion/transom or beam structure of a façade system, wherein the connecting element is not limited to a specific angular range able to accommodate deformations from orthogonal planes as the connecting elements in standard mullion/transom façade systems are.

A further task on which the invention is based is that of specifying a façade structure having a plurality of beam elements, wherein the beam structure enables even complex building geometries to be replicated.

Lastly, the invention is based on the task of specifying a method for producing a connecting element for a mullion/transom or beam structure of a façade system, wherein the connecting element can in particular be used as a connecting node even given complex building geometries, and wherein the method can be used to realize an optimized connecting element which always adapts to the varied geometries and loads of a building façade.

With respect to the connecting element, the task on which the invention is based is solved by the subject matter of claim 1, and with respect to the façade structure, by the subject matter of accompanying independent claims 12 and 13, whereby with respect to the method, the task on which the invention is based is solved by the subject matter of accompanying independent claim 14. Advantageous developments of the inventive connecting element and inventive method are specified in the corresponding subclaims.

Accordingly, the invention relates in particular to a connecting element for a mullion/transom or beam structure of a façade system which is able to be used as a connecting node, wherein the connecting element has a connecting body produced by an additive or generative manufacturing process for metals which consists of a plurality of different, three-dimensionally curved regions.

Various advantages can be realized by providing a corresponding connecting body formed by a plurality of respectively different, three-dimensionally curved regions.

In particular able to be thereby realized is a topology-optimized connecting element which is no longer limited to one specific angular range able to accommodate deformations from orthogonal planes.

The inventive connection system thereby enables broadening the angular range for significantly more complex geometries through the use of the optimized connecting element when utilizing standard façade system structural elements (in particular when using standardized mullion and/or transom elements) since the connecting element according to the invention always adapts to the varied geometries and loads of the façade.

An additive or generative manufacturing process for metals is used to produce the complex connecting body of the inventive connecting element. In particular, the connecting body of the inventive connecting element is produced from shapeless or neutrally shaped materials in an additive or generative manufacturing process for metals without the use of special tools and on the basis of computer datasets.

Serving as the basis for the metal additive or generative manufacturing process is a constructional process based on a parametric planning method. The data generated within the scope of the parametric planning method can be relayed to the corresponding device for generatively producing the parametrically planned connecting body via an interface, for example an STL interface.

All processes using metal as the source starting material are in particular suitable as generative or additive manufacturing processes. These for example include Selective Laser Sintering (SLS), Electron Beam Melting (EBM), Direct Metal Laser Sintering (DMLS), Selective Laser Melting (SLM), etc.

The connecting element according to the invention is thus a virtually created variable, geometry-optimized, material-optimized, load-optimized and production-optimized component for complex façade geometries which is conveyed as a production file to the selected machine for generative production and materialized into a directly usable façade component.

The inventive connecting element thereby combines software optimized to the planning process, geometry generation optimized to the manufacturing process and virtual simulation for construction approval (according to the respective manufacturing process and manufacturing material).

No connecting elements of this type are known or even available at the present time. All of the approaches known from the prior art, with connecting elements being produced using different manufacturing methods, need to be planned and manufactured individually for each connecting element application. Such connecting elements or respectively approaches are usually only economical through mass production of identical components; this, however, runs counter to the idea of complex geometry. Subtractive CNC machining processes or casting processes are frequently used in this regard. Yet the available methods do not allow producing each component (connecting element) differently and at the same time economically, which is essential for a material-optimized, load-optimized and production-optimized component (connecting element).

The inventive connecting element solves the limitations described at the outset and as occur with standard mullion/transom façade systems and for the first time offers a generatively or additively produced metal connecting element as a supplement to the standard mullion/transom systems currently available on the market.

With respective to the method according to the invention for the manufacture of such a connecting element, it is to be noted that the connecting element serving as a façade node, or at least a connecting body of the connecting element serving as a façade node respectively, is simulated and generated on a software basis, wherein this is preferably digitally automated, whereby the dataset created during the generation and simulation of the connecting element subsequently serves in the automatic producing of the connecting element by means of a suitable and in particular additive or generative manufacturing process for metals.

A software-based parameterized method is preferably used for generation and simulation.

The inventive connecting element is designed for connection to commercially available mullion/transom façade systems and in particular to mullion and transom elements of commercially available mullion/transom façade systems, but yet is not limited to a specific system product. A parametric adaptation of the basic component of the connecting element, and particularly parametric adaptations of the connecting body of the connecting element to the façade system requirements such as e.g. glass thicknesses, sealing systems, profile geometries, etc., enables complex geometries to be realized.

The advantage of combining components from standard façade systems with additively or generatively manufactured metal components is that of being able to use most standard accessory components such as, for example, sealing profiles, fastener elements, extrusion and cover profiles, etc. The respective generatively manufactured and topology-optimized connecting element is adapted to the different façades currently available on the market. For example, the necessary screw channels, sealing channels, drainage channels and connecting elements from the standard façade system are digitally modeled onto the generatively manufactured, topology-optimized connecting element and compatibility thus ensured.

The geometry of the inventive connecting element is parametrically generated. These parameters define the geometric relationship between the façade profiles to be connected. The virtual connecting element consists in particular of different areas, namely an outer side with the connections to the façade profiles. This area is referred to as “non-design space.”

Another area making up the virtual connecting element is referred to as “design space.”

While the first area, the “non-design space”, is responsible for ensuring the continuity of e.g. the drainage channels, the sealing channels and the screw channel and is adapted to the selected façade system, the second area, the “design space” area, comprises the volume able to be optimized for weight and cost reduction. Here, the software-based method optimizes the geometry of the second area of the virtual connecting element (i.e. the “design space” area) using algorithms based on the anticipated loads from the façade.

As previously indicated, the first area of the virtual connecting element, i.e. the “non-design space” area, is responsible for ensuring the continuity of e.g. the drainage channels, the sealing channels and the screw channel and is adapted to the selected façade system. Parametric generation thereby enables the connecting element to be adapted to a plurality of geometric inclinations from the adjoining façade surfaces. This creates a seamless connection between the profiles, which is geometrically impossible with conventional façade systems due to the complex profile sections in irregular surface inclinations and connections.

As a component, the fully generated digital model of the connecting element is immediately ready for additive or generative manufacturing and can be used directly in the façade after manufacture. Post-processing is not, however, thereby excluded (e.g. surface treatment, subsequent metallurgical treatment, etc.).

The above-described digital planning enables realistically depicting precise material parameters from the selected additive or generative manufacturing process for metals in the virtual illustration of the component. Optimization is achieved in the component in terms of the necessary force curves and on the respective additive or generative manufacturing device in terms of optimized production. The product is then optimized relative to material consumption and applied loads. Comparison to the stored material properties (elastic modulus, stability, etc.) provides the necessary evidence for obtaining construction sector approval on an individual case basis, and in particular without the need for fracture tests on each component.

Provided according to preferential embodiments of the inventive connecting element, which comprises the connecting body produced using an additive or generative manufacturing process for metals, and consists of a plurality of different, three-dimensionally curved regions, is for the three-dimensionally curved regions of the connecting body to run along previously calculated force flow vectors, whereby the force flow vectors correspond to a load acting on the connecting element in the connecting element's integrated state in the mullion/transom or beam structure.

In particular, the three-dimensionally curved regions run exclusively in the area of the calculated force flow vectors in order to thereby create a weight and material-optimized connecting element.

Preferably provided according to preferential implementations of the inventive connecting element is for the three-dimensionally curved regions of the generatively or additively manufactured connecting body to be of rod, strut or branch shape and even more preferentially at least substantially rod-shaped, strut-shaped or branch-shaped in at least areas or sections. Particularly provided in these embodiments is for at least areas or sections of the three-dimensionally curved regions to exhibit different material thicknesses and/or material densities. According to embodiments of the invention, the material thicknesses and/or material densities are selected pursuant to a calculated point or area load of the connecting element in an integrated state of the connecting element in the mullion/transom or beam structure. In particular, the areas of the connecting body of the connecting element which are subjected to a high stress load in the connecting element's integrated state in the façade structure have a greater material thickness and/or material density than areas of the connecting element subjected to a low or respectively lower stress load in the connecting element's integrated state in the façade structure.

The different material density distribution in the connecting body of the connecting element can additionally or alternatively be achieved by the application of one and the same material at selective points or areas.

The additive or generative manufacturing processes for metals can in particular be a 3D printing process such as, for example, a powder bed process, a free space method or another layering process. Examples of known powder bed processes are selective laser melting, selective laser sintering, selective heat sintering, binder jetting or electron beam melting. This is obviously not an exhaustive list.

As already noted, parametric planning methods are used in the design phase of the inventive connecting element. This refers to planning methods in which conceptual designs of the connecting element can be optimized according to specifically set parameters. Parametric planning is based on the system of all the elements of the connecting body being defined by parameters and thus able to react to one another. Because the parameters are linked to one another, each individual change leads to changes in other parts of the design. All the data which is relevant to the façade or connecting element is input and linked together such that an intelligent 3D model of the connecting element results. Parametric planning methods enable avoiding strict geometric shapes such as rectangles, triangles and circles in the connecting element, or connecting bodies respectively, as well as the repetition and apposition of unrelated elements. Particularly the three-dimensionally curved regions of the connecting body of the connecting element are to be regarded as being parametrically deformable.

Therefore, according to embodiments of the inventive connecting element, it is provided for the three-dimensionally curved regions of the connecting body to be parametrically defined. This applies in terms of curvature of the three-dimensionally curved regions, in terms of a three-dimensional orientation of the three-dimensionally curved regions, in terms of number of three-dimensionally curved regions, and in terms of the orientation of the three-dimensionally curved regions. The material thicknesses and/or material densities of the three-dimensionally curved regions are also preferably defined parametrically.

According to further developments of the inventive connecting element, it is provided for the connecting element to exhibit at least two interface areas realized separately from one another and each integrated into the connecting body, via which beam elements of the beam structure or mullion and/or transom elements of the mullion/transom structure can be connected to each other. The three-dimensionally curved regions are thereby preferably of rod, strut or branch shape and even more preferentially at least substantially rod-shaped, strut-shaped or branch-shaped in at least areas or sections, wherein the cross-sectional area of at least one three-dimensionally curved region increases toward the interface areas and/or wherein the material thickness and/or material density of at least one three-dimensionally curved region increases toward the interface areas. This thereby enables forces transmitted through the connecting body to be accordingly fanned out when introduced into the interface area and force peaks thus effectively prevented.

The invention further relates to a façade structure having at least one mullion element and at least one transom element, wherein the at least one mullion element is connected to the at least one transom element by way of a connecting element of the type according to the invention.

In this context, it is to be noted that the term “mullion element,” inasmuch as referred to herein in conjunction with the inventive connecting element, is not necessarily to be understood as a vertically aligned element. The same applies analogously to the term “transom element” used in conjunction with the inventive connecting element not necessarily meaning that this element has to run horizontally. The terms “mullion element” and “transom element” are thus only still used in conjunction with the inventive connecting element since they can be elements of a standard mullion/transom or beam structure.

According to a further aspect, the present invention thus also relates to a façade structure having at least one first and one second beam element, whereby the at least one first beam element is connected to the at least one second beam element by way of a connecting element of the type according to the invention.

The following will reference the accompanying drawings in describing the invention in greater detail on the basis of exemplary embodiments.

Shown are:

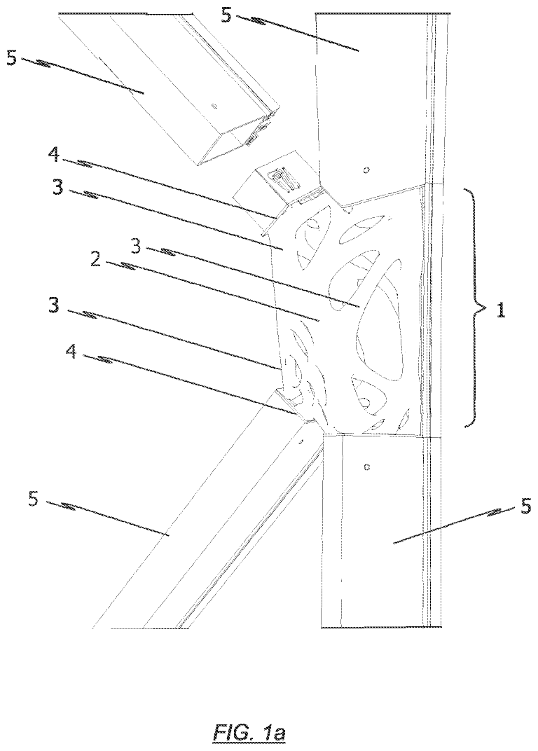

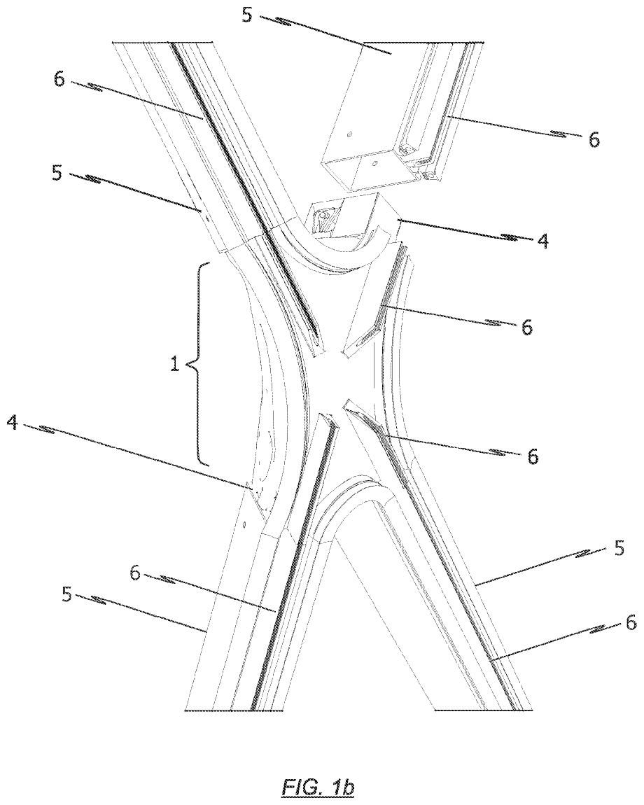

FIG. 1a a schematic and isometric view of the front side of a first exemplary embodiment of a connecting element according to the present invention;

FIG. 1b a schematic and isometric view of the rear side of the first exemplary embodiment of the connecting element according to FIG. 1a;

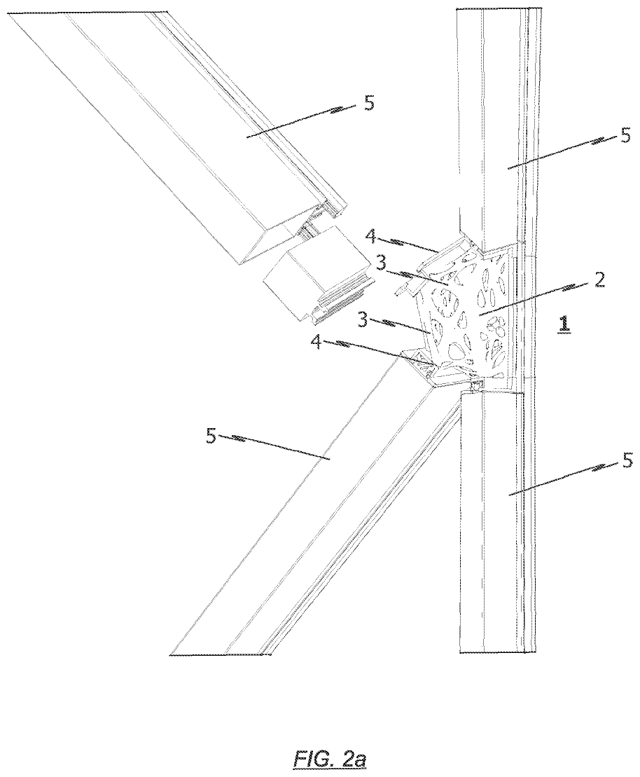

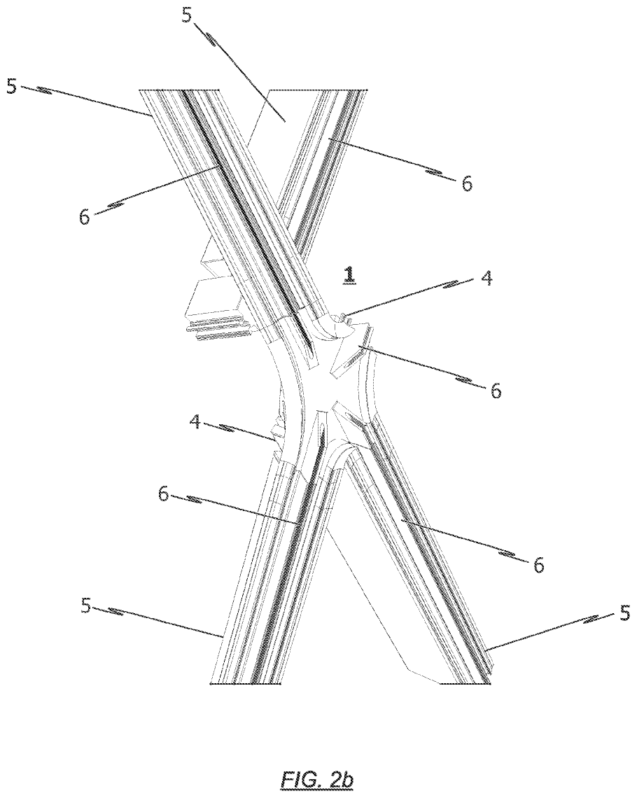

FIG. 2a a schematic and isometric view of the front side of a second exemplary embodiment of the inventive connecting element;

FIG. 2b a schematic and isometric view of the rear side of the second exemplary embodiment of the connecting element according to FIG. 2a;

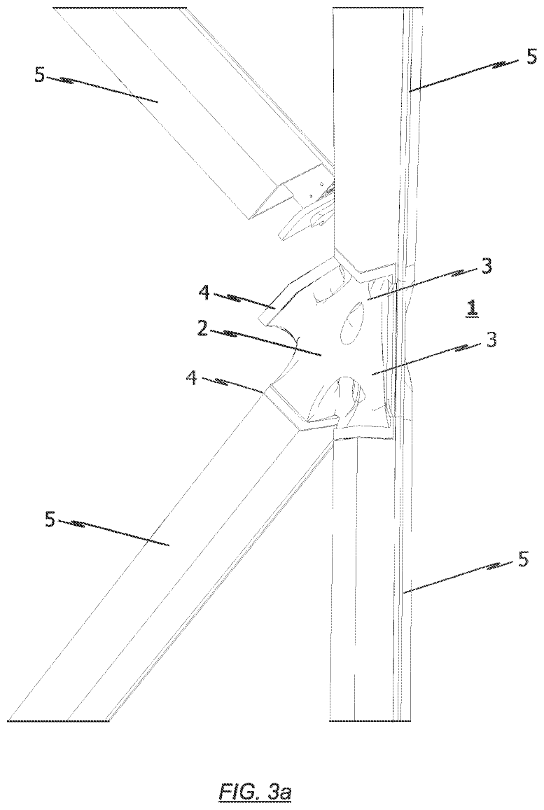

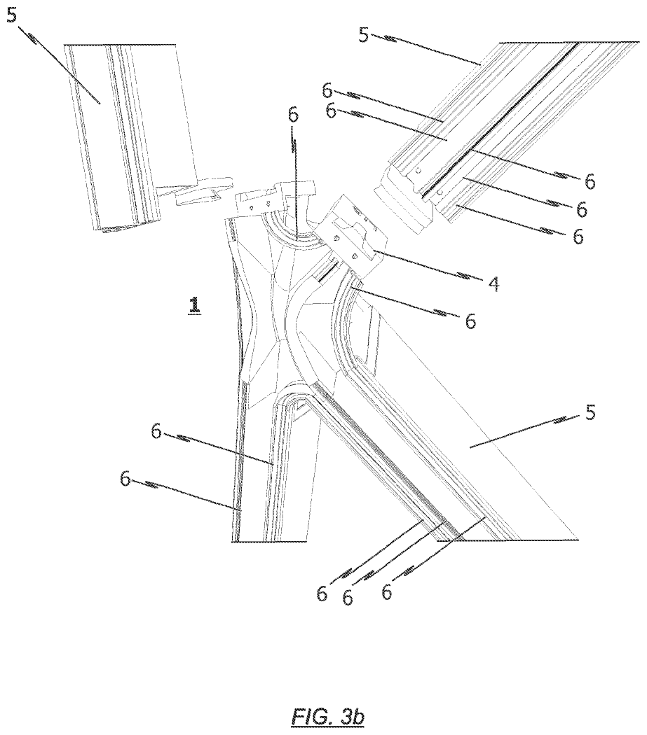

FIG. 3a a schematic and isometric view of the front side of a third exemplary embodiment of the inventive connecting element; and

FIG. 3b a schematic and isometric view of the rear side of the third exemplary embodiment of the connecting element according to FIG. 3a.

The following description of the figures uses the same reference numerals for the same or equivalent components of the different embodiments.

In a respective schematic and isometric view, FIG. 1a and FIG. 1b each show the front and rear side of a system having a generatively produced connecting element 1 formed integrally with a vertically extending façade profile and two interface areas 4 for receiving or respectively attaching corresponding façade profiles 5. In the embodiment depicted, the connecting body 2 of the connecting element 1 is generatively produced in a single operation, for example by means of a 3D printing process, and thus forms a monolith.

The connecting body 2 comprises a plurality of respectively different, three-dimensionally curved regions 3. These three-dimensionally curved regions 3 run along previously calculated force flow vectors.

As shown, the three-dimensionally curved regions 3 of the connecting body 2 in the first exemplary embodiment are in particular at least partly of rod, strut or branch shape and exhibit at least areas or sections of different material thicknesses and/or material densities. The material thicknesses and/or material densities are selected pursuant to a calculated point or area load of the connecting element 1 in an integrated state of the connecting element 1 in a façade structure.

As previously stated, the connecting element 1 according to the first exemplary embodiment has four separate interface areas 4 which are each integrated into the connecting body 2, by means of which façade elements 5, in particular façade profiles of the façade structure, can be connected together.

In the first exemplary embodiment, the interface areas 4 of the connecting body 2 are designed to receive the façade profiles 5 by the façade profiles 5 being at least partially fit onto the connecting areas and appropriately secured there.

A similar approach is used to connect the façade profiles 5 to the connecting body 2 in the embodiment depicted schematically in FIG. 2a and FIG. 2b, whereby a slip joint which is positively connectable to the interface areas of the connecting body 2 and serves to receive the façade profiles 5 is however used here.

The exemplary embodiment of the inventive connecting element 1 depicted schematically in FIG. 3a and FIG. 3b makes use of a topology-optimized solution, whereby the connection to the façade profiles 5 is effected by way of a standard sliding joint from the exterior of the connecting element 1 serving as a connecting node.

Particularly able to be recognized in the inventive connecting element 1, based on the rear views according to FIG. 1b, FIG. 2b and FIG. 3b, is that the drainage/sealing channels 6 of the façade profiles 5 connected to the connecting element 1 continue on in the connecting element in continuous manner.

The invention is not limited to the embodiments depicted in the drawings but rather yields from an integrated overall consideration of all the features as disclosed herein.

### LIST OF REFERENCE NUMERALS

1 connecting element

2 connecting body

3 three-dimensionally curved region

4 interface area

5 façade profile

6 drainage/sealing channel

1. A connecting element for a mullion/transom or beam structure of a façade system, wherein the connecting element comprises a connecting body produced by a generative manufacturing process, wherein the connecting body includes a plurality of different, three-dimensionally curved regions.

2. The connecting element according to claim 1, wherein the three-dimensionally curved regions run along previously calculated force flow vectors, wherein the force flow vectors correspond to a load acting on the connecting element in an integrated state of the connecting element in the mullion/transom or beam structure.

3. The connecting element according to claim 2, wherein each of the three-dimensionally curved regions run extend exclusively in an area of the calculated force flow vectors.

4. The connecting element according to claim 1, wherein each of the three-dimensionally curved regions is of a rod, strut or branch shape in at least areas or sections of the three-dimensionally curved regions, wherein the areas or sections of the three-dimensionally curved regions exhibit different material thicknesses and material densities.

5. The connecting element according to claim 4, wherein the material thicknesses and material densities are selected pursuant to a calculated point or area load of the connecting element in an integrated state of the connecting element in the mullion/transom or beam structure.

6. The connecting element according to claim 1, wherein each of the three-dimensionally curved regions is parametrically defined.

7. The connecting element according to claim 1, wherein each of the three-dimensionally curved regions is parametrically adapted to specifically calculated and predetermined requirements of the mullion/transom or beam structure or to specifically calculated and/or predetermined requirements of the façade system which is part of the mullion/transom or beam structure.

8. The connecting element according to claim 6, wherein a curvature of the three-dimensionally curved region, a three-dimensional orientation of the three-dimensionally curved regions, a number of the three-dimensionally curved regions and the orientation of the three-dimensionally curved regions are parametrically defined among one another.

9. The connecting element according to claim 4, wherein each of the material thicknesses and material densities of the three-dimensionally curved regions is defined parametrically.

10. The connecting element according to one of claim 1, wherein the connecting element exhibits includes at least two interface areas, wherein the at least two interface areas are separate from one another, and wherein each of the at least two interface areas is integrated into the connecting body, via which mullion and/or transom elements of the mullion/transom structure or beam elements of the beam structure are configured to be connected to each other.

11. The connecting element according to claim 10, wherein the three-dimensionally curved regions have a rod, strut or branch shape, wherein a cross-sectional area of at least one of the three-dimensionally curved regions increases toward the interface areas and wherein a material thickness and a material density of at least one of the three-dimensionally curved regions increases toward the interface areas.

12. A façade structure, comprising at least one first beam element and at least one second beam element, wherein the at least one first beam element is connected to the at least one second beam element by the connecting element according to claim 1.

13. A façade structure, comprising at least one mullion element and at least one transom element, wherein the at least one mullion element is connected to the at least one transom element by the connecting element according to claim 1.

14. A method for producing the connecting element for a mullion/transom or beam structure of a façade system according to claim 1, wherein the method comprises the steps of:
parametrically designing at least one connecting body of the connecting element; and
generatively producing at least the parametrically designed connecting body.

15. The method according to claim 14, wherein the parametrically designed connecting body has a plurality of respectively different, three-dimensionally curved regions of rod, strut or branch shape, wherein the three-dimensionally curved regions extend along previously calculated force flow vectors, wherein the force flow vectors correspond to a load acting on the connecting element in an integrated state of the connecting element in the mullion/transom or beam structure.

16. The method according to claim 14, further comprising the step of integrating at least two interface areas into the connecting body, wherein the integration of the at least two interface areas ensues generatively.

17. The method according to claim 14, wherein the parametric designing step further comprises verifying approvability of the connecting body by virtually simulating the connecting body.
